(19) United States
(12) Patent Application Publication
(10) Pub. No.: US 2010/0309675 A1
(43) Pub. Date: Dec. 9, 2010

(54) Lamp for Bicycle

(76) Inventor: Wen-Sung Lee, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/481,518

(22) Filed: Jun. 9, 2009

(51) Int. Cl. B62J 6/00

(52) U.S. Cl. 362/473

(57) ABSTRACT

A bicycle-used lamp includes a light source, a lens and a primary reflector. The light source is located at the origin of a coordinate system including a horizontal coordinate axis X, a vertical coordinate axis Y and another horizontal coordinate axis Y The light source emits light when energized. The lens is located at a distance from the light source along the coordinate axis Z for refracting a lower portion of the light and casting the refracted light onto the ground. The primary reflector is located at a distance from the light source along the coordinate axis Y for reflecting an upper portion of the light and directing the reflected light parallel to the coordinate axis Z.

### BACKGROUND OF INVENTION

1. Field of Invention

The present invention relates to a lamp and, more particularly, to a lamp for a bicycle.

2. Related Prior Art

Many people ride bicycles instead of riding motorcycles or scooters or driving cars to reduce environmental pollution and/or traveling expanses and/or stay fit and healthy concerns. A robust bicycle, proper garments and headgear and a reliable lamp are important for the safety of a rider.

Referring to FIG. 1, in a procedure for testing a lamp, illumination is measured 10 meters from the lamp. Illumination is measure in zones 1, 2, 3, HV, L1, L4, L5, R1, R4 and R5.

Although equipped with reflectors or diffusing elements, many lamps fail this test. A common reason for such failure is excessively high illumination in zone 1 that would bother a driver driving in an opposite direction. Another common reason for such failure is inadequate illumination in zone HV where illumination must be higher than 10 Lux in zone HV. Another common reason for such failure is inadequate illumination in zones below zone HV where illumination must be higher than 1.5 Lux.

The present invention is therefore intended to obviate or at least alleviate the problems encountered in prior art.

### SUMMARY OF INVENTION

It is the primary objective of the present invention to provide a reliable lamp for a bicycle.

To achieve the foregoing objective, the lamp includes a light source, a lens and a primary reflector. The light source is located at the origin of a coordinate system including a horizontal coordinate axis X, a vertical coordinate axis Y and another horizontal coordinate axis Y The light source emits light when energized. The lens is located at a distance from the light source along the coordinate axis Z for refracting a lower portion of the light and casting the refracted light onto the ground. The primary reflector is located at a distance from the light source along the coordinate axis Y for reflecting an upper portion of the light and directing the reflected light parallel to the coordinate axis Z.

Other objectives, advantages and features of the present invention will become apparent from the following description referring to the attached drawings.

### BRIEF DESCRIPTION OF DRAWINGS

The present invention will be described via detailed illustration of several embodiments referring to the drawings.

FIG. 1 is a front view of a vertical plane divided into various zones where illumination is measured according to a testing procedure.

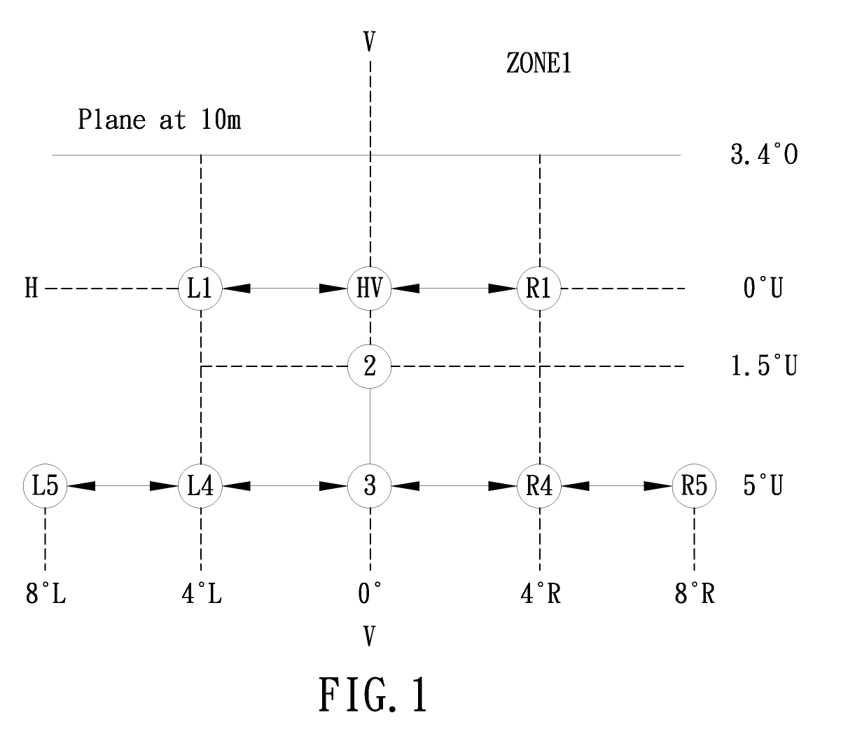

FIG. 2 is a front view of an illumination pattern in compliance with the testing procedure.

FIG. 3 is a top view of an illumination pattern in compliance with the testing procedure.

FIG. 4 is a perspective view of a lamp according to a first embodiment of the present invention.

FIG. 5 is a perspective view of a reflector of a lamp according to a second embodiment of the present invention.

FIG. 6 is a perspective view of a lamp according to a third embodiment of the present invention.

FIG. 7 is a top view of a lens of the lamp shown in FIG. 6.

FIG. 8 is a perspective view of a reflector of the lamp shown in FIG. 6.

FIG. 9 is a perspective view of a lamp according to a fourth embodiment of the present invention.

### DETAILED DESCRIPTION OF EMBODIMENTS

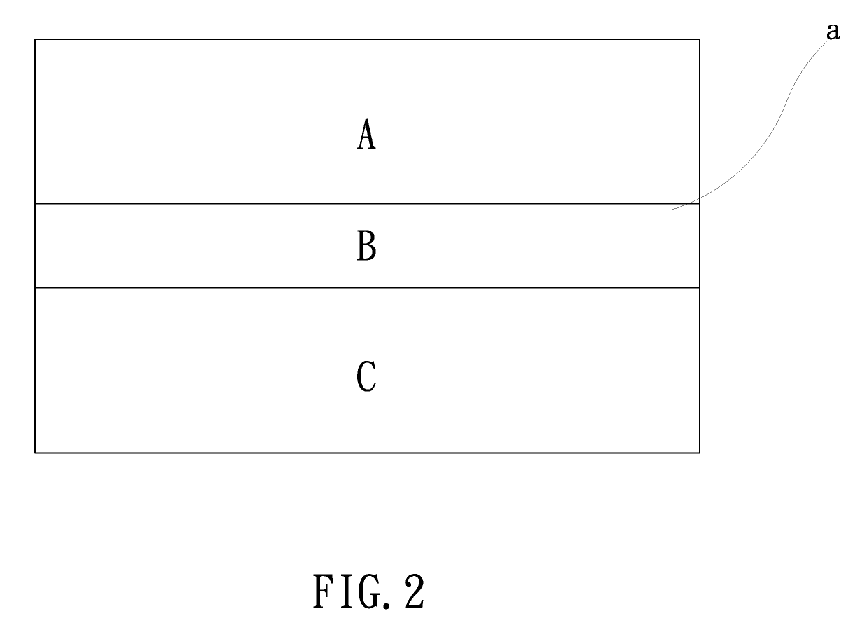

Referring to FIG. 2, there is shown an illumination pattern in compliance with the testing procedure mentioned in the RELATED PRIOR ART. There are regions A, B, C and a in a vertical plane 10 meters from a lamp.

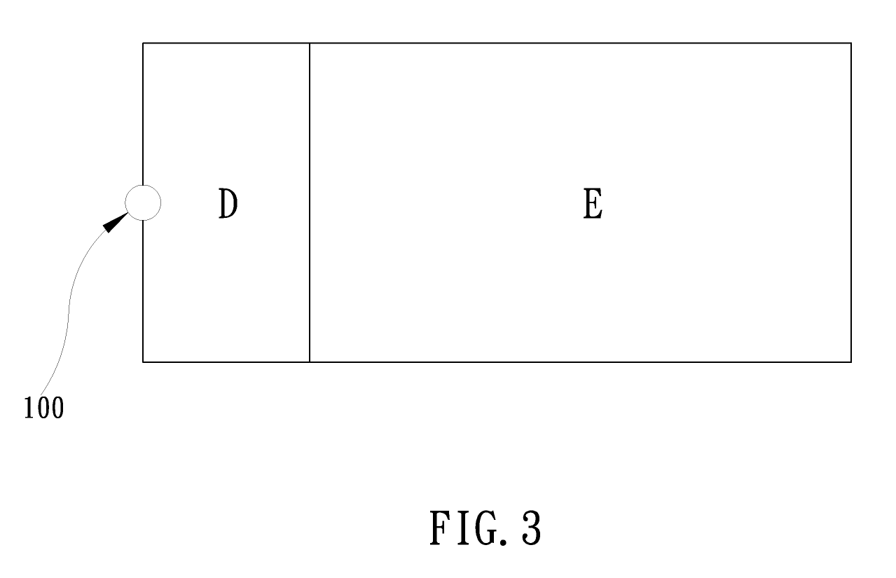

Referring to FIG. 3, there is shown an illumination pattern in compliance with the testing procedure mentioned in the RELATED PRIOR ART. There are zones D and E. The zone D is within 10 meters in front of a lamp 100. The zone E is more than 10 meters in front of the lamp 100.

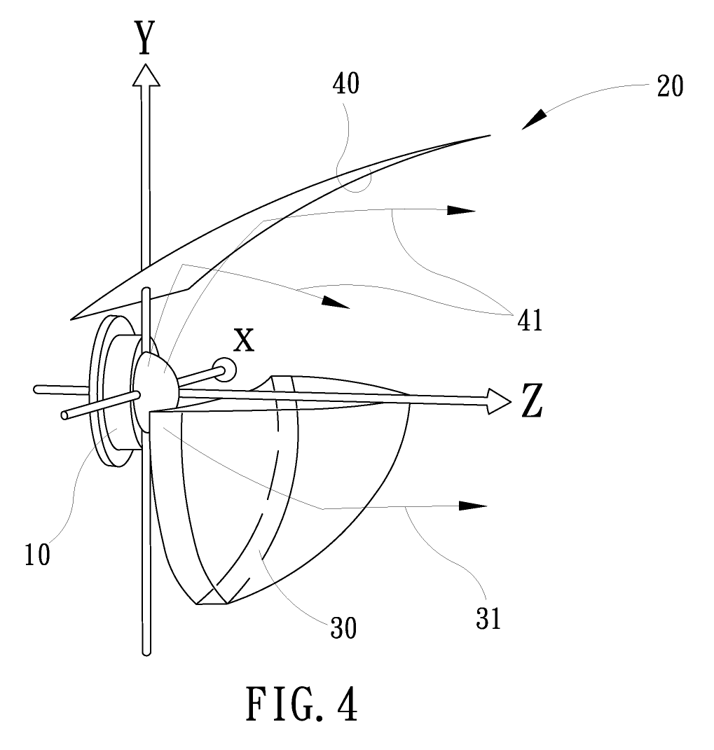

Referring to FIG. 4, for the convenience of description, a coordinate system is defined. There is a coordinate axis X. Another coordinate axis Y is perpendicular to the axis X. Another coordinate axis Z is perpendicular to the axes X and Y.

A lamp 20 includes a light source 10, a lens 30 and a reflector 40 according to a first embodiment of the present invention. The light source 10 is located at the origin of the coordinate system. The light source 10 can be a light bulb, a light-emitting diode (“LED”) or an LED array for example. When energized, the light source 10 emits light.

The lens 30 is located at a distance from the light source 10 along the coordinate axis Z. The lens 30 is a hemi-circle viewed along the coordinate axis Z. A lower portion of the light goes through the lens 30 and gets refracted and becomes refracted light 31. The lens 30 includes a planar surface from which the lower portion of the light enters the lens 30 and a convex surface from which the lower portion of the light leaves the lens 30. The convex surface is a part of a spherical surface for example. The convex surface is made with a curvature radius adapted for refracting the lower portion of the light and casting the refracted light 31 onto the ground and, more particularly, into the zones D and E. It is desired that illumination in the zone E is in compliance with illumination in the zone C.

The reflector 40 is located at a distance from the light source 10 along the coordinate axis Y. The reflector 40 can be a planar or curved element. The reflector 40 includes a reflective side and a non-reflective side opposite to the reflective side. An upper portion of the light travels to the reflector 40 and gets reflected and becomes reflected light 41. The reflector extends along a parabola in a cross-sectional view taken in a plane parallel to the Y-Z plane. Thus, the reflector 40 reflects the upper portion of the light and directs the reflected light 41 parallel to the coordinate axis Z.

The lamp 20 provide proper illumination in the zones A, B, C and a shown in FIG. 2 and the zones D and E shown in FIG. 3.

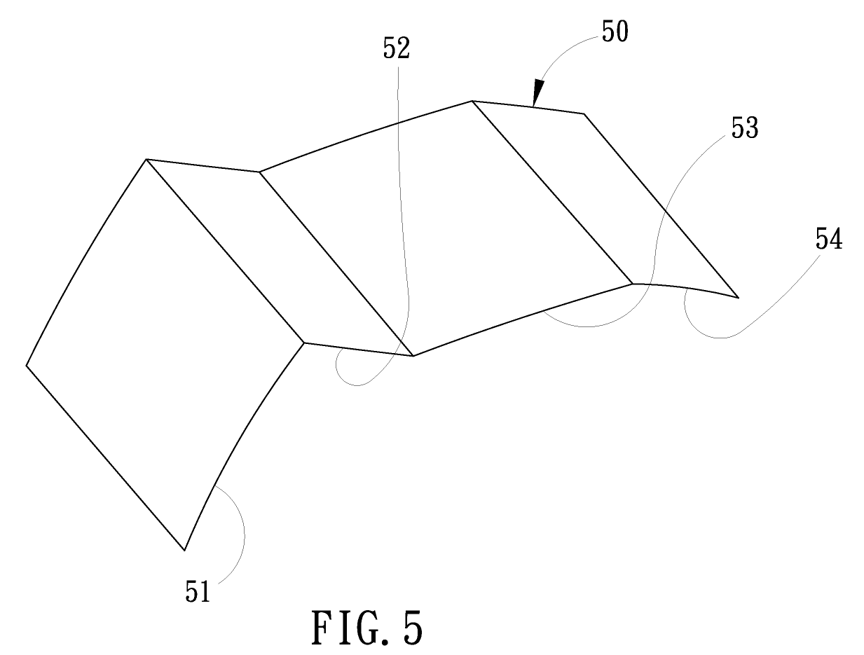

Referring to FIG. 5, a reflector 50 of a lamp according to a second embodiment of the present invention is shown. The reflector 50 is like the reflector 40 except including a bent structure consisting of portions 51, 52, 53 and 54. Each of the portions 51, 52, 53 and 54 reflects a portion of the light. The portions 51 and 53 of the reflector 50 cast light in a direction parallel to the coordinate axis Z. The portions 52 and 54 of the reflector 50 cast light onto the ground and, more particularly, into the zones D and E, thus enhancing the illumination in the zones D and E.

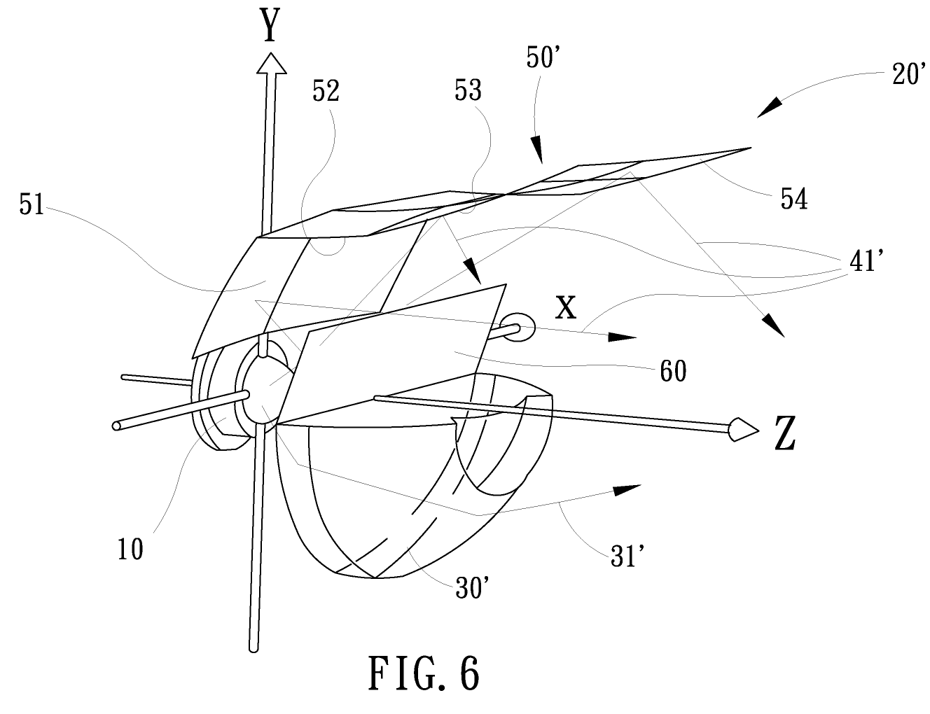

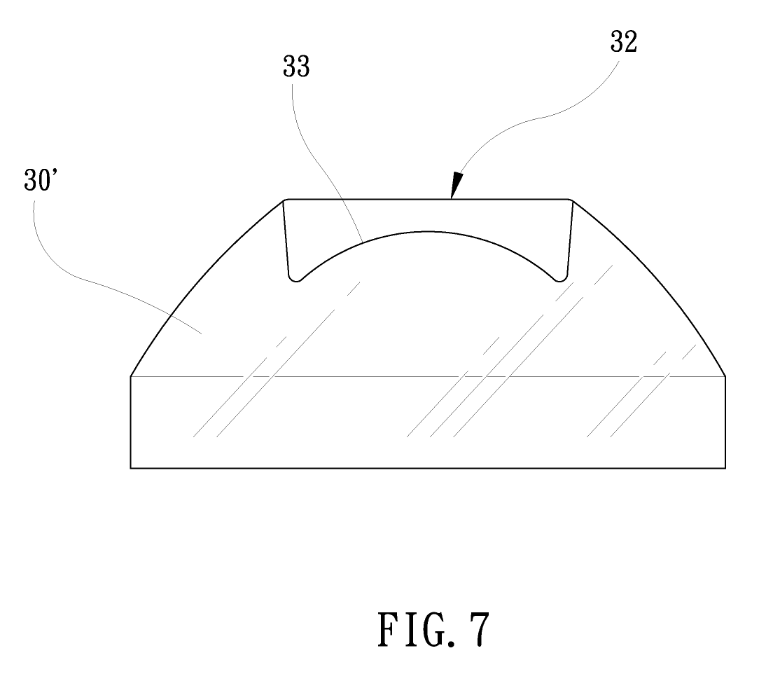

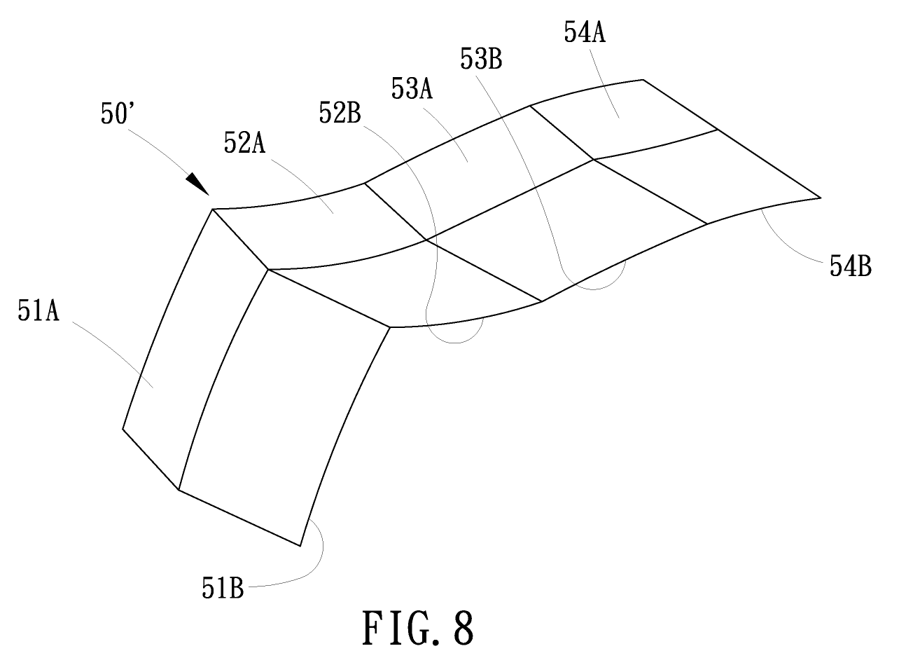

Referring to FIGS. 6 to 8, a lamp 20′ according to a third embodiment of the present invention is shown. The lamp 20′ is like the lamp 20 except several things. Firstly, a lens 30′ is used instead of the lens 30. The lens 30′ is like the lens 30 except including a cavity 32 defined therein. The cavity 32 includes a convex floor 33 as a part of a spherical surface for example. With the cavity 32, the thickness and weight of the lens 30 are reduced, without effecting the illumination.

Secondly, a reflector 50′ is used instead of the reflector 40. The reflector 50′ is like the reflector 40 except including a bent configuration consisting of eight areas 51A, 51B, 52A, 52B, 53A, 53B, 54A and 54B. Each of these portions 51A, 51B, 52A, 52B, 53A, 53B, 54A and 54B reflects in a desired direction. The portions 51A, 51B, 53A and 53B of the reflector 50′ cast light in a direction parallel to the X-Z plane. The portions 52A, 52B, 54A and 54B of the reflector 50′ cast light onto the ground and, more particularly, into the zones D and E, thus enhancing the illumination in the zones D and E.

Thirdly, an additional reflector 60 is located at a certain distance from the light source 10 along the coordinate axis Z. The reflector 60 reflects some of the upper portion of the light to the reflector 50′, which reflects the upper portion of the light again.

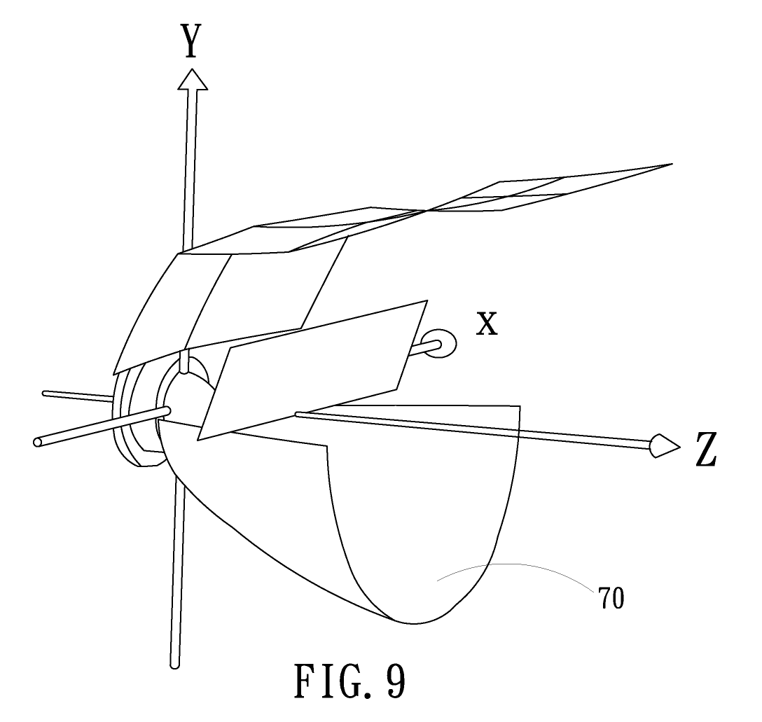

Referring to FIG. 9, a lamp according to a fourth embodiment of the present invention is shown. The fourth embodiment is like the third embodiment except including a reflector 70 instead of the lens 30′. The reflector 70 reflects the lower portion of the light.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A bicycle-used lamp comprising:
a light source located at the origin of a coordinate system including a horizontal coordinate axis X, a vertical coordinate axis Y and another horizontal coordinate axis Y, wherein the light source emits light when energized;
a lens located at a distance from the light source along the coordinate axis Z for refracting a lower portion of the light and casting the refracted light onto the ground; and
a primary reflector located at a distance from the light source along the coordinate axis Y for reflecting an upper portion of the light and directing the reflected light parallel to the coordinate axis Z.

2. The bicycle-used lamp according to claim 1, wherein the lens looks like a hemi-circle along the coordinate axis Z.

3. The bicycle-used lamp according to claim 1, wherein the primary reflector extends along a parabola in a cross-sectional view taken in a plane parallel to the primary reflector extends along a parabola in a cross-sectional view taken in a plane parallel to the Y-Z plane.

4. The bicycle-used lamp according to claim 1, wherein the primary reflector comprises:
a first portion for casting a portion of the light in a direction parallel to the coordinate axis Z;
a second portion extended from the first portion and used to cast another portion of the light onto the ground;
a third portion extended from the second portion and used to cast another portion of the light in a direction parallel to the coordinate axis Z; and
a second portion extended from the first portion and used to cast another portion of the light onto the ground.

5. The bicycle-used lamp according to claim 4, wherein each of portions of the primary reflector is divided into two halves.

6. The bicycle-used lamp according to claim 1, wherein the lens comprises a planar surface from which the lower portion of the light enters the lens and a convex surface from which the lower portion of the light leaves the lens.

7. The bicycle-used lamp according to claim 6, wherein the lens comprises a cavity in the convex surface, and the cavity comprises a convex floor so that the thickness and weight of the lens are reduced without effecting the illumination.

8. The bicycle-used lamp according to claim 1 comprising an auxiliary reflector for reflecting the upper portion of the light to the auxiliary reflector.

9. A bicycle-used lamp comprising:
a light source located at the origin of a coordinate system including a horizontal coordinate axis X, a vertical coordinate axis Y and another horizontal coordinate axis Y, wherein the light source emits light when energized;
a lower reflector located at a distance from the light source along the coordinate axis Z for reflecting a lower portion of the light and casting the refracted light onto the ground; and
an upper reflector located at a distance from the light source along the coordinate axis Y for reflecting an upper portion of the light and directing the reflected light parallel to the coordinate axis Z.

10. The bicycle-used lamp according to claim 9, wherein the upper reflector extends along a parabola in a cross-sectional view taken in a plane parallel to the upper reflector extends along a parabola in a cross-sectional view taken in a plane parallel to the Y-Z plane.

11. The bicycle-used lamp according to claim 9, wherein the upper reflector comprises:
a first portion for casting a portion of the light in a direction parallel to the coordinate axis Z;
a second portion extended from the first portion and used to cast another portion of the light onto the ground;
a third portion extended from the second portion and used to cast another portion of the light in a direction parallel to the coordinate axis Z; and
a second portion extended from the first portion and used to cast another portion of the light onto the ground.

12. The bicycle-used lamp according to claim 11, wherein each of portions of the upper reflector is divided into two halves.

13. The bicycle-used lamp according to claim 9 comprising a middle reflector for reflecting the upper portion of the light to the upper reflector.
